(19) United States
(12) Patent Application Publication
(10) Pub. No.: US 2013/0262893 A1
(43) Pub. Date: Oct. 3, 2013

(54) POWER ESTIMATION DEVICE AND POWER ESTIMATION METHOD

(71) Applicant: FUJITSU LIMITED, Kawasaki-shi (JP)

(72) Inventor: Takayuki SASAKI, Kawasaki (JP)

(73) Assignee: FUJITSU LIMITED, Kawasaki-shi (JP)

(21) Appl. No.: 13/850,424

(22) Filed: Mar. 26, 2013

(30) Foreign Application Priority Data
Mar. 30, 2012 (JP) 2012-079779

(51) Int. Cl. G06F 1/32

(52) U.S. Cl. CPC G06F 1/3215
USPC 713/321

(57) ABSTRACT

A power estimation apparatus includes a storage unit, a functional model generation unit, and a power estimation unit. The storage unit stores the amount of power per clock transition in a circuit operation that consumes power. The functional model generation unit generates a functional model in which a pin that allows passage of a clock during the circuit operation that consumes power is added. The power estimation unit calculates the amount of power needed during the circuit operation, by operating on a toggle rate of the clock passed through the pin and the amount of power stored in the storage unit.

### CROSS-REFERENCE TO RELATED APPLICATION

This application is based upon and claims the benefit of priority of the prior Japanese Patent Application No. 2012-079779, filed on Mar. 30, 2012, the entire contents of which are incorporated herein by reference.

### FIELD

The embodiments discussed herein are related to a power estimation apparatus, and a power estimation method.

### BACKGROUND

Application specific integrated circuits (ASICs) are custom integrated circuits (ICs) designed for particular applications. Generally, unlike general-purpose chips, ASICs are designed as new dedicated devices in accordance with specifications given by equipment manufacturers.

When developing an ASIC, a circuit corresponding to the logical space is generated by describing the circuit in a hardware description language (HDL), with use of cells (basic logical gates) that are provided as a library in advance and a plurality of types of macros (single circuit block having a particular function).

The HDL is a logic description language used to design integrated circuits. Among HDLs, Verilog HDL is widely used as a logic simulator for digital circuit design, for example.

Upon designing an ASIC, power consumption is estimated. The estimation is often performed using a power estimation tool that displays the results of the power consumption estimation in accordance with input data.

Many power estimation tools use a pin-based method that obtains the power value by performing probability propagation calculation based on the toggle rate and probability at a pin of the cell.

The toggle rate indicates the number of signal transitions per unit time. For example, the toggle rate is expressed as the number of toggles/ns. The probability indicates the proportion of the high-level interval of a signal per unit time. For example, if 70% of the total interval of a signal per unit time is high level, the probability is 0.7.

The pin-based method is advantageous in that it is possible to perform power estimation at high speed, and that it is possible to provide maintainability for flexibly responding to addition of functions.

As one of related-art techniques for calculating power consumption, there has been proposed a method for calculating power consumption of a circuit using an actual pattern method in combination with a probability propagation method (see, for example, Japanese Laid-open Patent Publication No. 2000-207425). As another related-art technique, there has been proposed a method for calculating power consumption when a logic circuit is operated on the basis of the operation rate of each of functional blocks, a combinational circuit, and flip-flops (see, for example, Japanese Laid-open Patent Publication No. 2009-205270).

However, if power consumption of a memory macro is calculated by performing such a related-art probability propagation calculation that uses the pin-based method, variations in the toggle rate mainly affect the probability propagation calculation, and therefore tend to cause an error. This may result in an inaccurate estimation of power consumption.

For example, in the case of a memory macro using a clock gating circuit, even between the same write operations or between the same read operations, there may be a difference in the calculated power consumption value, depending on whether a clock is supplied.

### SUMMARY

According to one aspect of the invention, there is provided a power estimation apparatus that includes: a memory configured to store an amount of power per clock transition in a circuit operation that consumes power; and a processor configured to perform a procedure including: generating a functional model in which a pin that allows passage of a clock during the circuit operation is added, and calculating an amount of power needed during the circuit operation, by operating on a toggle rate of the clock passed through the pin and the amount of power stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a power estimation apparatus;

FIG. 2 illustrates an exemplary configuration of a circuit simulation apparatus;

FIG. 3 illustrates a flow of a power estimation operation;

FIG. 4 illustrates an exemplary RAM list file;

FIG. 5 illustrates an exemplary design data for a RAM;

FIG. 6 illustrates an exemplary library;

FIG. 7 illustrates a simulation model;

FIG. 8 illustrates waveforms of pins of a RAM;

FIG. 9 illustrates waveforms of pins of a RAM;

FIG. 10 illustrates an exemplary configuration of a circuit simulation apparatus;

FIG. 11 illustrates an exemplary hardware configuration of a computer;

FIG. 12 illustrates a simulation model;

FIG. 13 illustrates waveforms of pins of a RAM;

FIG. 14 illustrates an exemplary library;

FIG. 15 illustrates a flow of a generation operation of generating a simulation model and a library for a RAM;

FIG. 16 illustrates an exemplary RAM list file;

FIG. 17 illustrates an exemplary RAM and ROM parameter calculation model;

FIG. 18 illustrates an exemplary RAM parameter value list;

FIG. 19 illustrates an exemplary simulation model template for a 1RW-RAM;

FIG. 20 illustrates an exemplary simulation model template for a 1RW-RAM;

FIG. 21 illustrates an exemplary output of a simulation model;

FIG. 22 illustrates an exemplary library cell template;

FIG. 23 illustrates an exemplary library cell template; and

FIG. 24 illustrates an exemplary output of a library.

### DESCRIPTION OF EMBODIMENTS

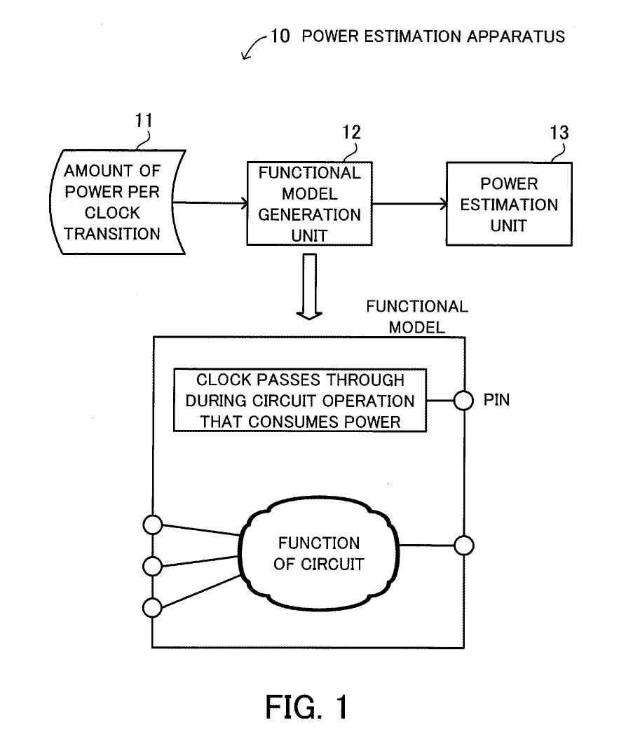

Several embodiments will be described below with reference to the accompanying drawings, wherein like reference numerals refer to like elements throughout. FIG. 1 illustrates an exemplary configuration of a power estimation apparatus 10. The power estimation apparatus 10 includes a storage unit 11, a functional model generation unit 12, and a power estimation unit 13.

The storage unit 11 stores the amount of power per clock transition in a circuit operation that consumes power (for example, a read operation or a write operation in a memory macro, and the like).

The functional model generation unit 12 generates a functional model in which a pin that allows passage of a clock during a circuit operation that consumes power is added.

In the case where a plurality of types of circuit operations that consume power are performed, a plurality of pins may be provided.

The power estimation unit 13 calculates the amount of power needed during the circuit operation, by operating on the toggle rate of the clock passed through the pin and the amount of power stored in the storage unit 11.

As described above, the power estimation apparatus 10 is provided with the pin that allows passage of a clock during a circuit operation that consumes power, and calculates the amount of power needed during the circuit operation, by operating on the toggle rate of the clock passed through the pin and a predetermined power value stored in the storage unit 11.

Accordingly, it is possible to prevent errors in estimating the power value. For example, according to a related-art technique, in the case of a memory macro using a clock gating circuit, even between the same write operations or between the same read operations, there may be a difference in the calculated power consumption value, depending on whether a clock is supplied. However, with the power estimation apparatus 10, it is possible to prevent such a difference.

Next, before explaining the present technique, the problem to be solved will be described in detail. Note that the following describes, among memory macros, a random access memory (RAM) as a subject circuit which is to be generated or is under verification.

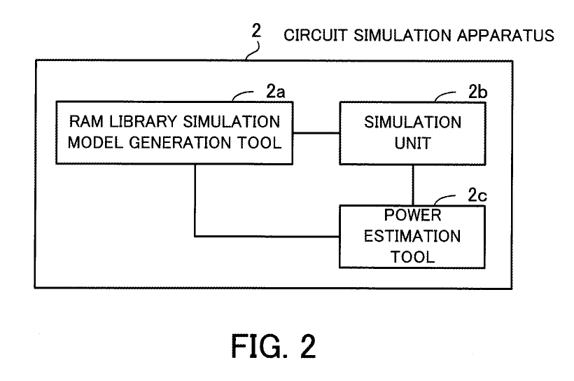

FIG. 2 illustrates an exemplary configuration of a related-art circuit simulation apparatus 2. The related-art circuit simulation apparatus 2 includes a RAM library simulation model generation tool 2a, a simulation unit 2b, and a power estimation tool 2c.

The RAM library simulation model generation tool 2a generates a library and a simulation model on the basis of a RAM list file.

The simulation unit 2b obtains a simulation waveform on the basis of the simulation model and design data, and calculates the probability and toggle rate of each port of the memory. The power estimation tool 2c calculates the power value of the subject circuit from the design data, information in the library, the probability, the toggle rate, and so on.

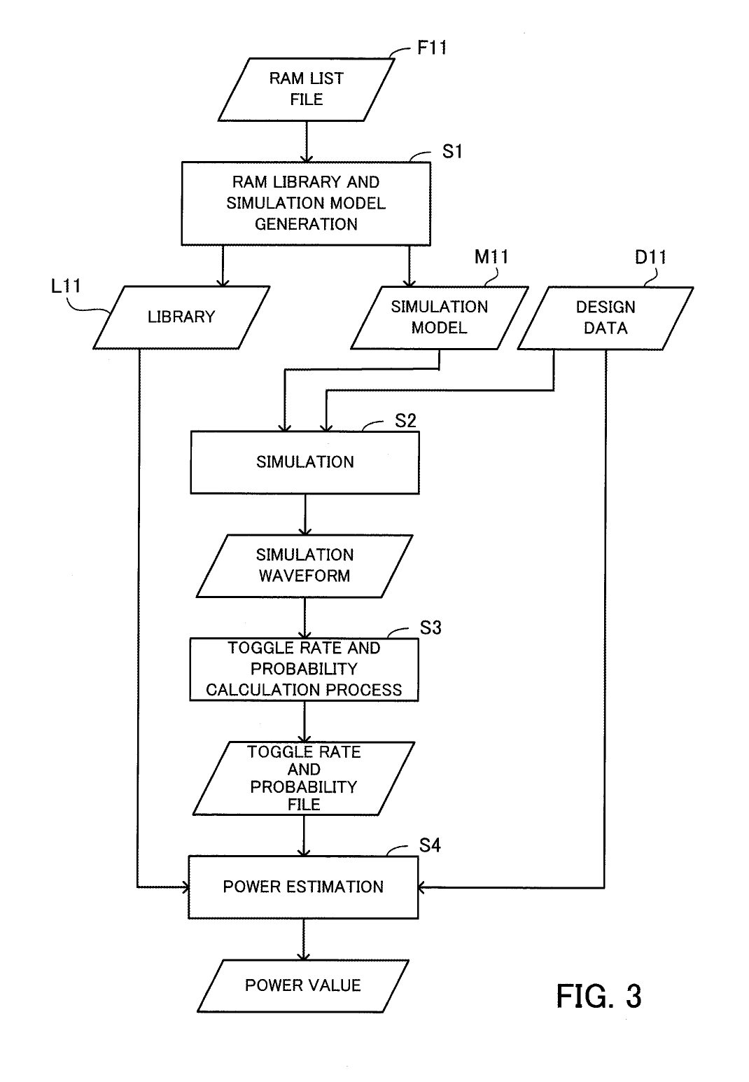

FIG. 3 illustrates a flow of a power estimation operation. More specifically, FIG. 3 illustrates a power estimation flow in the circuit simulation apparatus 2.

(S1) The RAM library simulation model generation tool 2a generates a library L11 and a simulation model M11 on the basis of a RAM list file F11.

(S2) The simulation unit 2b executes a simulation, on the basis of the simulation model M11 and design data D11, so as to obtain a simulation waveform.

(S3) The simulation unit 2b calculates the toggle rate and the probability from the simulation waveform, and registers the calculation results in a toggle rate and probability file.

(S4) The power estimation tool 2c calculates the power value of the subject circuit from information in the library L11, the design data D11, and the toggle rate and probability registered in the toggle rate and probability file.

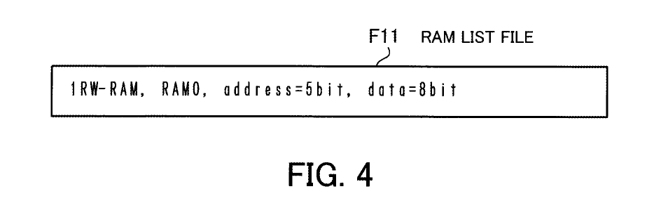

The following describes steps S1 through S4 in greater detail. First, step S1 will be described. FIG. 4 illustrates an exemplary RAM list file F11. The RAM list file F11 is an example of a file that indicates a module to be created by the RAM library simulation model generation tool 2a.

The RAM list file F11 instructs creation of a single-port RAM0 (1RW-RAM) with an address width of 5 bits and a data width of 8 bits.

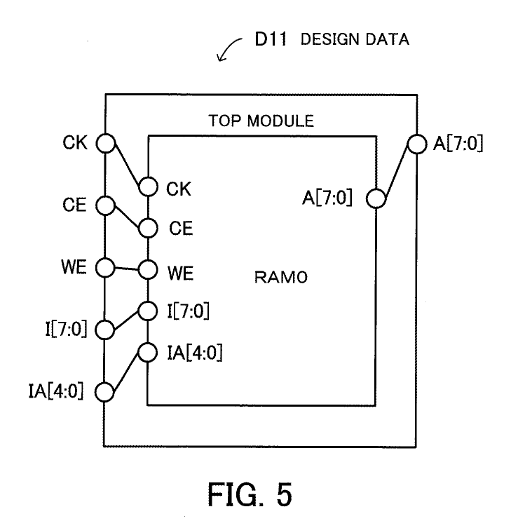

FIG. 5 illustrates an exemplary design data D11 for a RAM. The design data D11 indicates a top module of a model in which a single RAM0 is created. A CK pin, a CE pin, a WE pin, an I[7:0] pin, an IA[4:0] pin, and an A[7:0] pin are connected to the RAM0.

The CK pin is a pin to which clock is input. The CE pin is a chip enable pin, and the WE pin is a write enable pin. Note that both the CE pin and the WE pin are low active.

The I[7:0] pin is a data input pin. The IA[4:0] pin is an address input pin, and the A[7:0] pin is an output pin. Note that “[b:a]” indicates a range from bit “a” to bit “b” (for example, “IA[4:0]” indicates an address input pin of a total of 5 bits from bit 0 to bit 4).

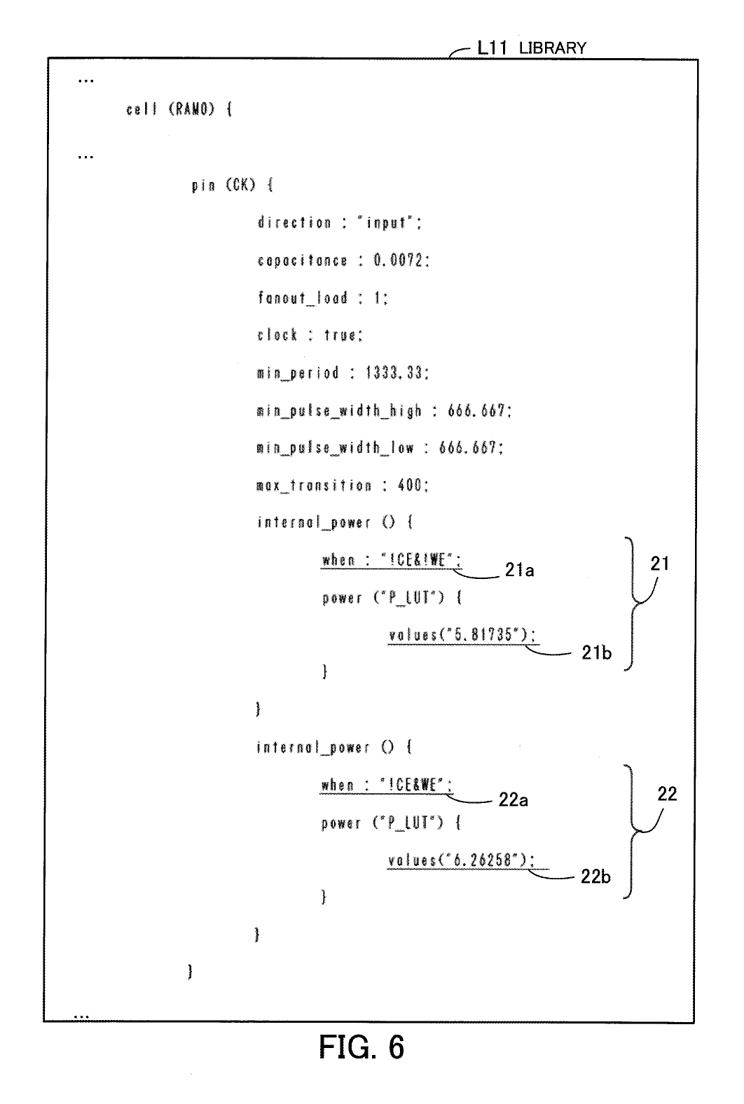

FIG. 6 illustrates an exemplary library L11. The RAM library simulation model generation tool 2a generates the library L11. The description of the library L11 includes the power value of the CK pin of the RAM0.

Referring to a sentence 21, “!CE&!WE” in a clause 21a indicates that both the CE pin and the WE pin are LOW. That is, the clause 21a indicates the condition that the RAM0 is in the write state (note that “!” indicates negation (inversion)).

Further, “values(“5.81735”)” in a clause 21b indicates that the predetermined power consumption value per toggle of the CK pin is 5.81735. Accordingly, the sentence 21 indicates that, during writing into the RAM0, the power consumed by one toggle of clock is 5.81735.

On the other hand, referring to a sentence 22, “!CE&WE” in a clause 22a indicates that the CE pin is LOW and the WE pin is HIGH. That is, the clause 22a indicates the condition that the RAM0 is in the read state.

Further, in a clause 22b, “values(“6.26258”)” indicates that the predetermined power consumption value per toggle of the CK pin is 6.26258. Accordingly, the sentence 22 indicates that, during reading from the RAM0, the power consumed by one toggle of clock is 6.26258.

Then in step S2, upon designing the RAM0, the simulation unit 2b executes a simulation on the basis of inputs such as various data values, a simulation model, a test bench, and so on.

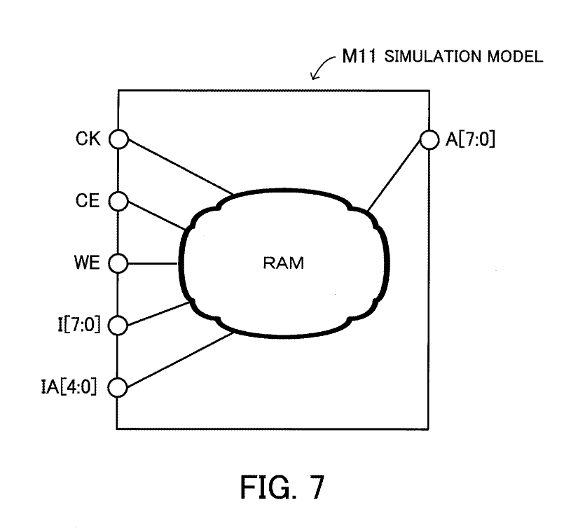

FIG. 7 illustrates a simulation model. This simulation model is a related-art simulation model M11 for the RAM0 (1RW-RAM) whose behavior is written in HDL, and is used in an HDL description. From the simulation by the simulation unit 2b, it is possible to obtain waveform data of the RAM0 and to obtain waveforms of the respective pins of the RAM0.

Then in step S3, the simulation unit 2b performs a toggle rate and probability calculation process on the basis of the simulation waveform data, and registers the calculation results in the toggle rate and probability file.

The toggle rate and probability file is a file in which the toggle rate and probability of each pin are written. As file formats of the toggle rate and probability file, a toggle count format (TCF), a switching activity interchange format (SAIF), and the like are known.

In step S4, the power estimation tool 2c calculates power consumption on the basis of the design data D11, the library L11, and the toggle rate and probability file. Further, in the case where an arithmetic expression for probability propagation is defined in the library L11, the value of power consumption is calculated using the arithmetic expression.

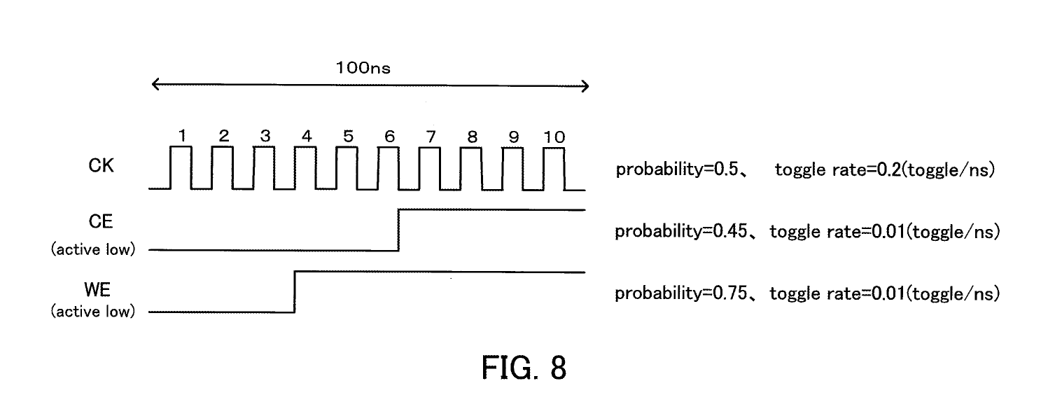

Next, calculation of power consumption will be described with reference to specific exemplary waveforms. FIG. 8 illustrates waveforms of the respective pins of the RAM0. More specifically, FIG. 8 illustrates waveforms of the CK pin, CE pin, and WE pin of the RAM0 in a 100 ns interval.

The probability and toggle rate of each pin are as follows. The probability and toggle rate of the CK pin are probability=0.5 and toggle rate=0.2 (toggle/ns) (=100 MHz).

Further, the probability and toggle rate of the CE pin are probability=0.45 and toggle rate=0.01 (toggle/ns). The probability and toggle rate of the WE pin are probability=0.75 and toggle rate=0.01 (toggle/ns).

The probability (!CE&!WE) during writing to the RAM0 is calculated as follows. In the case of FIG. 8, probability (!CE)=1−0.45=0.55, and probability (!WE)=1−0.75=0.25.

The probability of A&B is calculated by probability (A)×probability (B). Accordingly, the probability during writing to the RAM0 is calculated as probability (!CE&!WE)=0.55×0.25=0.1375.

Further, the probability (!CE&WE) during reading from the RAM0 is calculated as probability (!CE&WE)=0.55×0.75=0.4125.

Thus, the toggle rate of the CK pin during writing to the RAM0 is 0.0275 (=0.2×0.1375), and the toggle rate of the CK pin during reading from the RAM0 is 0.0825 (=0.2×0.4125).

Accordingly, in FIG. 8, the power consumption during writing to the RAM0 is calculated as 0.0275×5.81735. Further, in FIG. 8, the power consumption during reading from the RAM0 is calculated as 0.0825×6.26258.

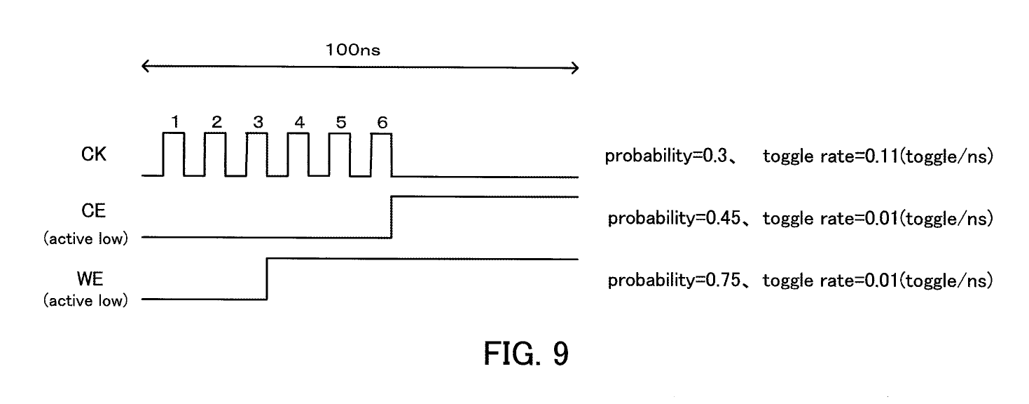

FIG. 9 illustrates waveforms of the respective pins of the RAM0. More specifically, FIG. 9 illustrates waveforms of the CK pin, CE pin, and WE pin in the case where the clock supply is stopped halfway.

In some memory macros, such as RAMs and read only memories (ROMs), a clock gating circuit is used.

The clock gating circuit stops the clock supply to a circuit when the circuit does not need to operate, and thereby reduces power consumption. In the case of FIG. 9, the clock is supplied in the interval during which the CE pin is asserted, and the clock supply is stopped in the interval during which the CE pin is not asserted.

The probability and toggle rate of each pin of the RAM0 of FIG. 9 are as follows. The probability and toggle rate of the CK pin are probability=0.3 and toggle rate=0.11 (toggle/ns) (=55 MHz).

Further, the probability and toggle rate of the CE pin are probability=0.45 and toggle rate=0.01 (toggle/ns). The probability and toggle rate of the WE pin are probability=0.75 and toggle rate=0.01 (toggle/ns).

Then, the probability during writing to the RAM0 is probability (!CE&!WE)=0.1375. Further, the probability during reading from the RAM0 is probability (!CE&WE)=0.4125.

Thus, the toggle rate of the CK pin during writing to the RAM0 is 0.015125 (=0.11×0.1375), and the toggle rate of the CK pin during reading from the RAM0 is 0.045375 (=0.11×0.4125).

Accordingly, in FIG. 9, the power consumption during writing to the RAM0 is calculated as 0.015125×5.81735. Further, in FIG. 9, the power consumption during reading from the RAM0 is calculated as 0.045375×6.26258.

The calculated toggle rate during writing to the RAM0 is 0.0275 in FIG. 8, while the calculated toggle rate during writing to the RAM0 is 0.015125 in FIG. 9. That is, there is a significant difference between the two values.

Further, the calculated toggle rate during reading from the RAM0 is 0.0825 in FIG. 8, while the calculated toggle rate during reading from the RAM0 is 0.045375 in FIG. 9. That is, there is a significant difference between the two values.

The toggle rate of the CK pin under the condition specified by the “when ( . . . )” clause in the library L11 of FIG. 6 is supposed to be calculated using the same arithmetic expression. Accordingly, the toggle rate during writing in FIG. 8 and the toggle rate during wiring in FIG. 9 need to have the same value. Also, the toggle rate during reading in FIG. 8 and the toggle rate during reading in FIG. 9 need to have the same value.

However, as illustrated in FIGS. 8 and 9, when the clock supply statuses differ from each other, the toggle rate during writing in FIG. 8 and the toggle rate during writing in FIG. 9 differ significantly from each other. Thus, there is a difference in the calculated power consumption value even between the same write operations (similarly, there is a difference in the calculated power consumption value even between the same read operations).

As described above, when the power consumption of a memory macro having a clock gating circuit is calculated using the above-described probability propagation calculation, the value of the toggle rate varies depending on whether a clock is supplied or the clock supply is stopped. Therefore, for example, even if the same write operations or the same read operations are performed, there is a difference in power consumption depending on whether a clock is supplied.

The present technique has been made in view of the above problems, and aims to provide a power estimation apparatus, a power estimation method, and a program which are capable of accurately estimating power consumption without any error.

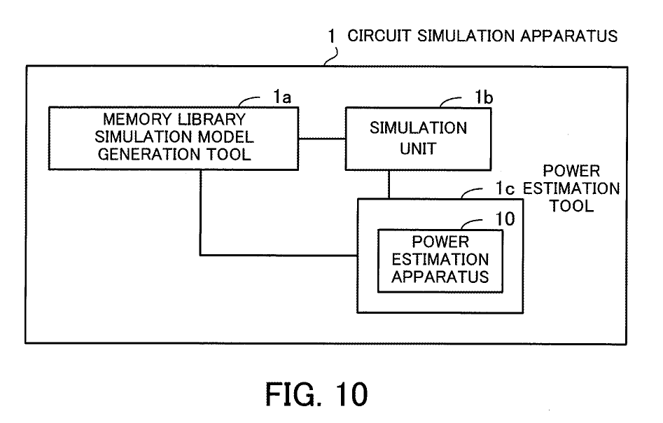

Next, a circuit simulation apparatus 1 having the functions of the power estimation apparatus 10 of FIG. 1 will be described. FIG. 10 illustrates an exemplary configuration of the circuit simulation apparatus 1. The circuit simulation apparatus 1 includes a memory library simulation model generation tool 1a, a simulation unit 1b, and a power estimation tool 1c. The power estimation tool 1c has functions of the power estimation apparatus 10 of FIG. 1.

The memory library simulation model generation tool 1a generates a library and a simulation model on the basis of a RAM list file.

The simulation unit 1b obtains a simulation waveform on the basis of the simulation model and design data, and calculates the probability and toggle rate of each port of the memory. The power estimation tool 1c calculates the power value of the subject circuit from the design data, information in the library, the probability, the toggle rate, and the like.

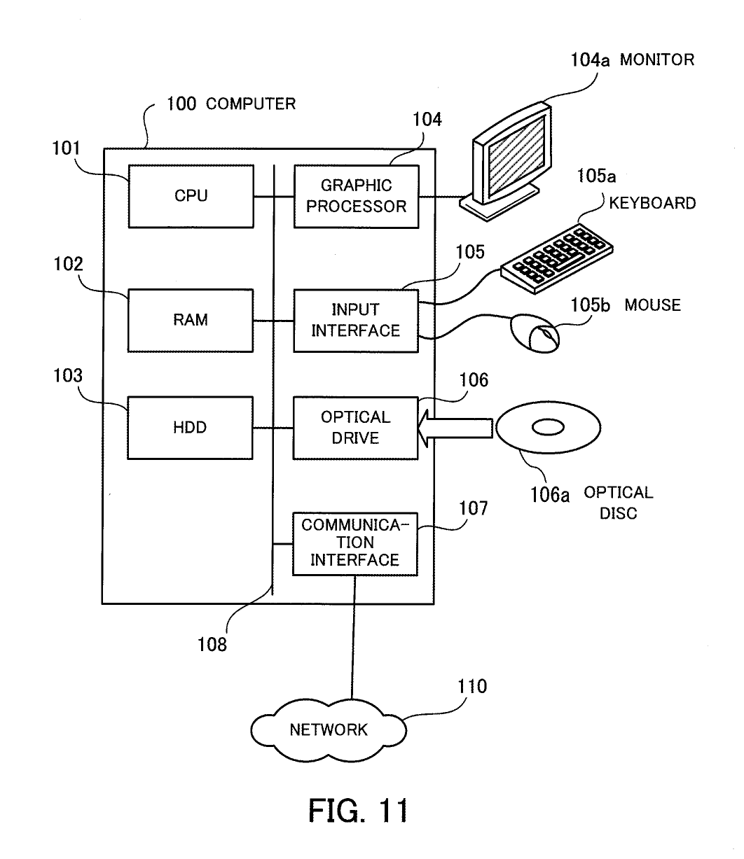

Note that the above-described processing functions of the circuit simulation apparatus 1 may be implemented on a computer. FIG. 11 illustrates an exemplary hardware configuration of a computer 100. The entire operation of the computer 100 of this embodiment is controlled by a CPU 101. A RAM 102 and a plurality of peripheral devices are connected to the CPU 101 via a bus 108.

The RAM 102 serves as a primary storage device of the computer 100. The RAM 102 temporarily stores at least part of the operating system (OS) program and application programs to be executed by the CPU 101. The RAM 102 also stores various types of data to be used for processing by the CPU 101.

The peripheral devices connected to the bus 108 include a hard disk drive (HDD) 103, a graphic processor 104, an input interface 105, an optical drive 106, and a communication interface 107.

The HDD 103 magnetically writes data to and reads data from an internal disk. The HDD 103 serves as a secondary storage device of the computer 100. The HDD 103 stores the OS programs, application programs, and various types of data. Note that a semiconductor storage device such as a flash memory may alternatively be used as a secondary storage device.

A monitor 104a is connected to the graphic processor 104. The graphic processor 104 displays images on the screen of the monitor 104a in accordance with a command from the CPU 101. Examples of the monitor 104a include a display device using a cathode ray tube (CRT), a liquid crystal display device, and the like.

A keyboard 105a and a mouse 105b are connected to the input interface 105. The input interface 105 receives signals from the keyboard 105a and the mouse 105b, and transmits the received signals to the CPU 101. Note that the mouse 105b is an example of a pointing device, and other types of pointing devices may also be used. Examples of other types of pointing devices include a touch panel, a tablet, a touch pad, a track ball, and the like.

The optical drive 106 reads data from an optical disc 106a, using laser beams or the like. The optical disc 106a is a portable storage medium storing data such that the data may be read using optical reflection. Examples of the optical disc 106a include a digital versatile disc (DVD), a DVD-RAM, a compact disc read only memory (CD-ROM), a CD-Recordable (CD-R), a CD-Rewritable (CD-RW), and the like.

The communication interface 107 is connected to a network 110. The communication interface 107 exchanges data with other computers and communication apparatuses via the network 110. With the hardware configuration described above, it is possible to realize the processing functions of this embodiment.

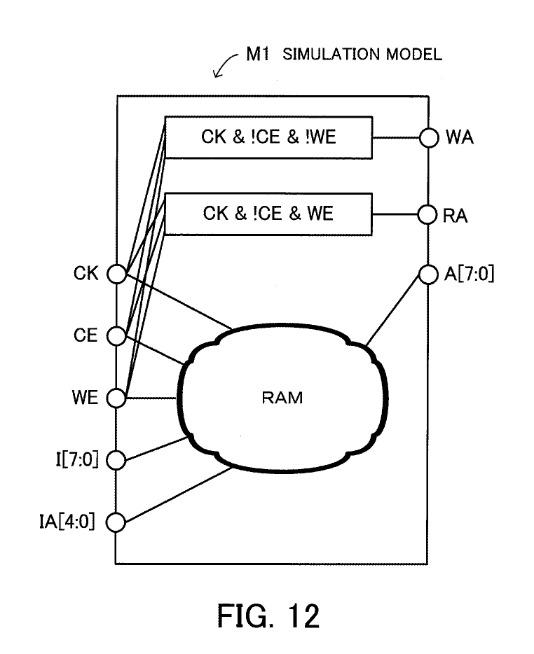

Next, power estimation process will be described in detail. FIG. 12 illustrates a simulation model. More specifically, FIG. 12 illustrates a simulation model M1 for a RAM which is generated with the present technique.

The related-art simulation model M11 of FIG. 7 only has RAM ports (pins). On the other hand, the simulation model M1 has monitor pins in addition to RAM ports.

More specifically, a WA pin that allows passage of a clock during writing, and a RA pin that allows passage of a clock during reading are added.

That is, since the period in which writing is performed is defined as !CE&!WE, the WA pin is a pin that allows passage of a clock under the condition of !CE&!WE. On the other hand, since the period in which reading is performed is defined as !CE&WE, the RA pin is a pin that allows passage of a clock under the condition of !CE&WE.

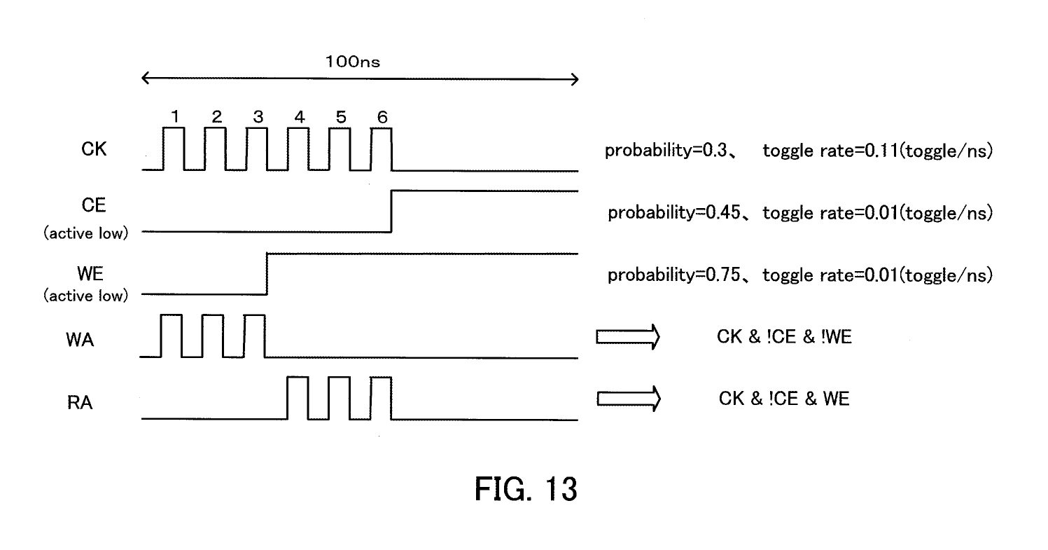

FIG. 13 illustrates waveforms of the respective pins of the RAM. More specifically, FIG. 13 illustrates waveforms obtained from a simulation of the simulation model M1 of FIG. 12. If the WE pin becomes LOW while the CE pin is asserted, and thus the RAM is placed in a write state, the WA pin allows passage of the clock.

If the WE pin becomes HIGH and thus the RAM is placed in a read state, or if the CE pin is not asserted, the WA pin becomes LOW and prevents passage of the clock.

If the WE pin becomes HIGH while the CE pin is asserted, and thus the RAM is placed in the read state, the RA pin allows passage of the clock.

If the WE pin becomes LOW and thus the RAM is placed in a write state, or if the CE pin is not asserted, the RA pin becomes LOW and prevents passage of the clock.

In the case of FIG. 13, both the WA pin and the RA pin have a toggle rate of 0.055 (toggle/ns). That is, since the toggle rate in the case of six clocks is 0.11 (toggle/ns), the toggle rate of both the WA pin and the RA pin is 0.055 (=0.11/2).

Further, since the predetermined value of power consumption per toggle of the CK pin during writing is 5.81735, the power consumption during writing is 0.055×5.81735. That is, (the toggle rate at the time when (!CE&!WE))×5.81735 is calculated.

Further, since the predetermined value of power consumption per toggle of the CK pin during reading is 6.26258, the power consumption during reading is 0.055×6.26258. That is, (the toggle rate at the time when (!CE&WE))×6.26258 is calculated.

In this way, the same toggle rate is used for calculation of the power consumption during writing and for calculation of the power consumption during reading. Accordingly, in a memory macro having a clock gating circuit, for example, the value of the toggle rate does not vary depending on whether a clock is supplied or the clock supply is stopped.

Therefore, if the same write operations or the same read operations are performed, there is no difference in power consumption depending on whether a clock is supplied. This allows accurate calculation of power consumption.

Note that the WA pin and the RA pin are floating pins, and hence are recognized as pins that are not connected on the design data. However, the WA pin and the RA pin are present in the waveform, and therefore are recorded in the toggle rate and probability file.

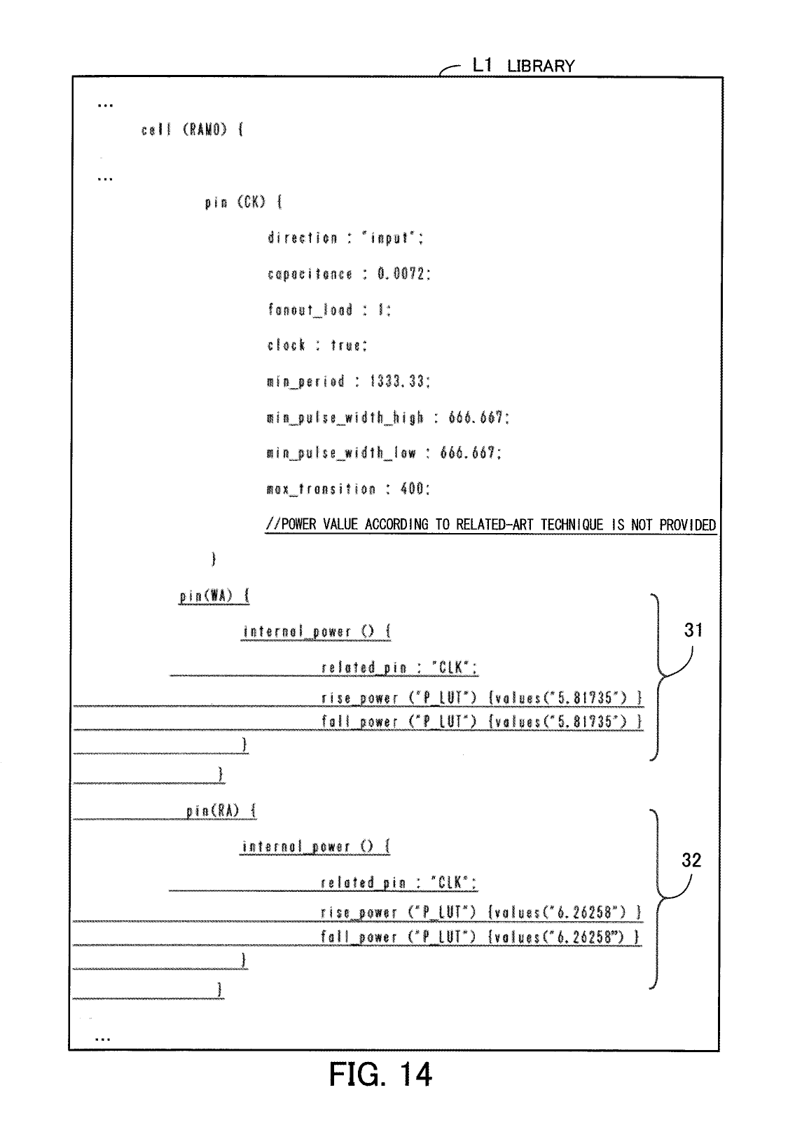

FIG. 14 illustrates an exemplary library L1. In the related-art library L11 of FIG. 6, a condition specified by a “when ( . . . )” clause is provided in the description of the CK pin for calculation of power.

On the other hand, the power estimation tool lc modifies the simulation model by providing the WA pin that allows passage of a clock only during writing and the RA pin that allows passage of a clock only during reading. Therefore, the library L1 of FIG. 14 does not need to include a “when ( . . . )” clause.

According to the definition of a pin (WA) described in a sentence 31, power is consumed when a change is made in the WA pin. In the sentence 31, “rise power” indicates a rise of the clock during writing, and “fall power” indicates a fall of the clock during writing. The amount of power per clock transition during writing is defined as 5.81735.

Similarly, according to the definition of a pin (RA) described in a sentence 32, power is consumed when a change is made in the RA pin. In the sentence 32, “rise power” indicates a rise of the clock during reading, and “fall power” indicates a fall of the clock during reading. The amount of power per clock transition during reading is defined as 6.26258.

As described above, in the power estimation apparatus 10, pins that allow passage of a clock during writing and reading, respectively, are added in a functional model of a memory macro, and the power consumption is calculated on the basis of the toggle rate of the clock that passes through each of the pins and the predetermined power value.

In this way, the library and the simulation model generated for the memory macro are modified so as to be suitable for the power estimation tool. This makes it possible to prevent the power estimation tool of the pin-based method from making errors in estimating the power value of the memory macro. This also makes it possible to improve the accuracy with low costs. Note that while the above description has illustrated the RAM, it is possible to prevent, even in the case of ROMs, errors in estimating the power value by performing a similar power estimation process.

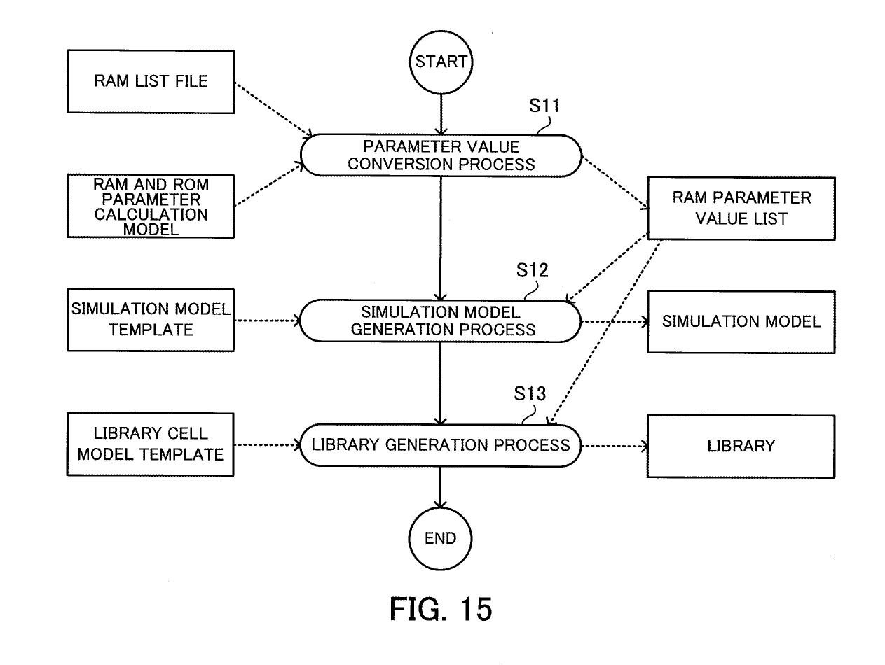

Next, a generation operation of generating a simulation model and a library for a RAM in the circuit simulation apparatus 2 will be described with reference to a specific example. FIG. 15 illustrates a flow of the generation operation of generating a simulation model and a library for a RAM.

(S11) The CPU 101 performs a parameter value conversion process, on the basis of a RAM list file and a RAM and ROM parameter calculation model, so as to generate a RAM parameter value list.

(S12) The CPU 101 generates a simulation model on the basis of the RAM parameter value list and a simulation model template.

(S13) The CPU 101 generates a library on the basis of the RAM parameter value list and a library cell model template.

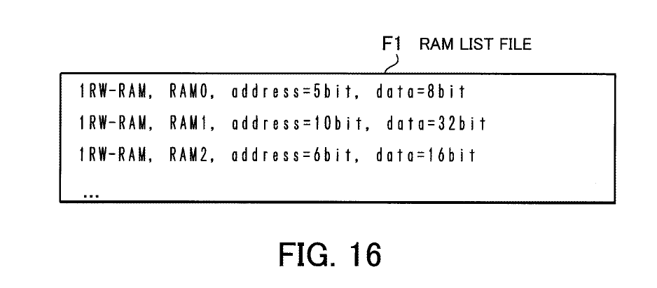

The following describes steps S11 through S13 in greater detail. First, the parameter value conversion process of step S11 will be described. FIG. 16 illustrates an exemplary RAM list file F1. The RAM list file F1 defines the RAM type, the RAM module name, the address line width, and the data line width.

For example, referring to a RAM on the top of the list, the RAM list file F1 defines that the RAM type is 1RW-RAM; the module name is RAM0; the address line width is 5 bits; and the data line width is 8 bits.

On the basis of this RAM list file F1, the CPU 101 generates RAMs, each with specified RAM type, module name, address line width, and data line width.

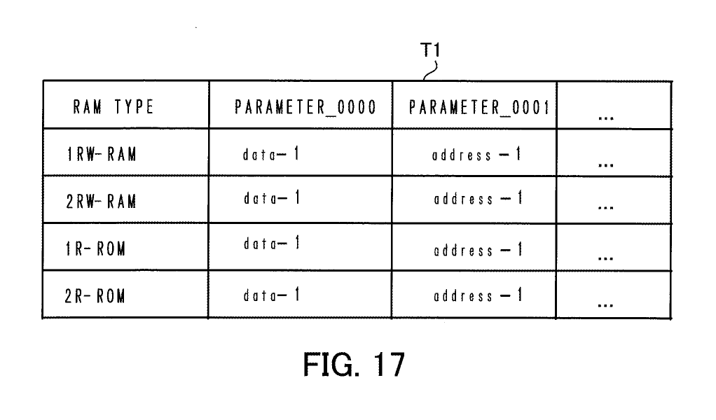

FIG. 17 illustrates an exemplary RAM and ROM parameter calculation model. A table T1 defines expressions for calculating various derived parameters on the basis of the parameter values specified in FIG. 16.

For example, referring to the RAM type “1RW-RAM”, the table T1 defines that PARAMETER 0000 is calculated by data-1, and PARAMETER 0001 is calculated by address-1.

In this way, the CPU 101 performs a parameter value conversion process, and thereby generates parameters needed by the RAM and ROM parameter calculation model for each of the modules defined in the RAM list file F1.

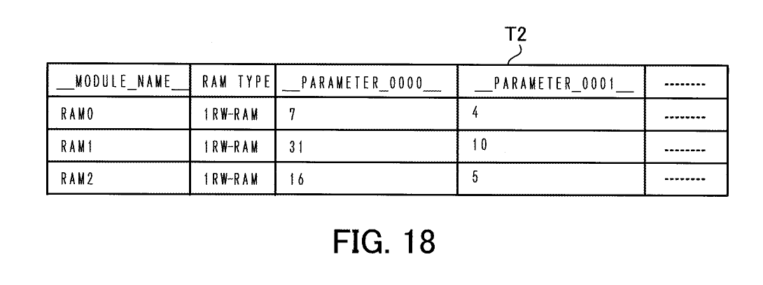

FIG. 18 illustrates an exemplary RAM parameter value list. A RAM parameter value list table T2 has the following fields: MODULE NAME, RAM TYPE, and PARAMETER.

For example, referring to the RAM with the module name “RAM0” (1RW-RAM), PARAMETER 0000=7, PARAMETER 0001=4, and so on are stored as the results of the parameter value conversion process. In this manner, the results of the parameter value conversion process are registered in the RAM parameter value list table T2.

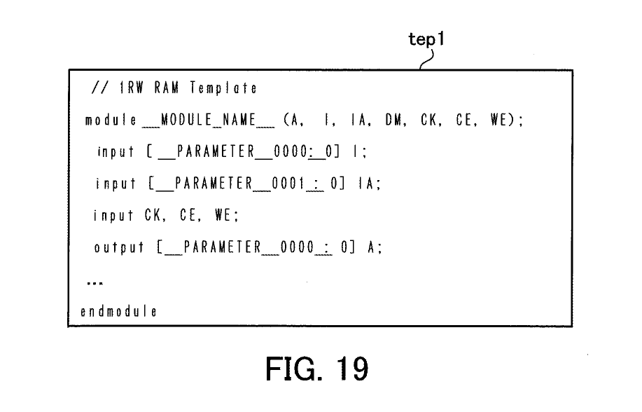

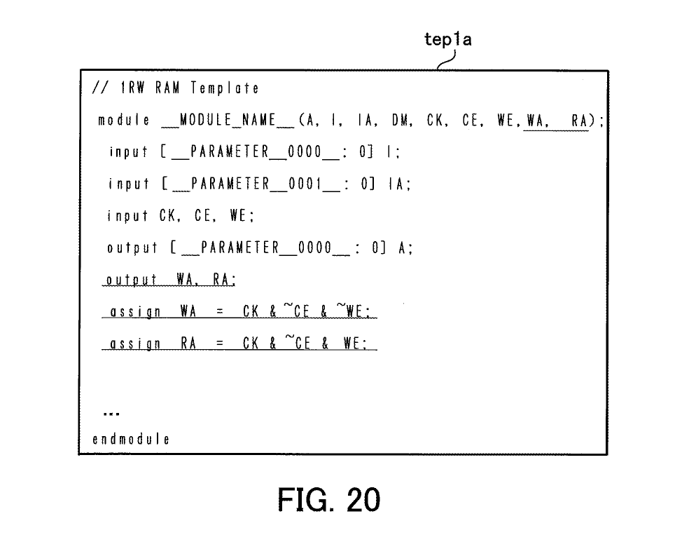

Next, a simulation model generation process of step S12 will be described. FIGS. 19 and 20 illustrate exemplary simulation model templates for a 1RW-RAM.

More specifically, FIG. 19 illustrates a related-art simulation model template tep1, and FIG. 20 illustrates a simulation model template tepla according to the present technique.

In each simulation model template, parameters are embedded in the portions indicated by “_MODULE NAME_”, “PARAMETER_<NUMBER>_”, and so on.

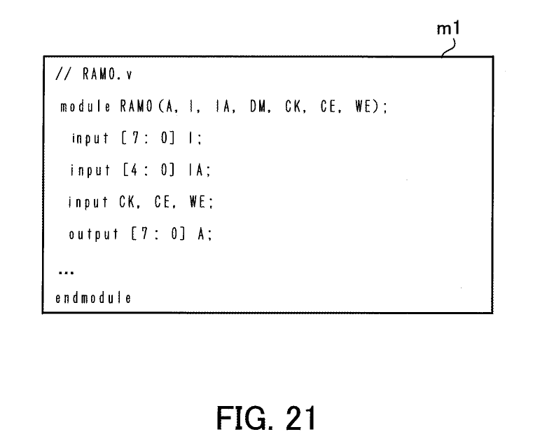

The CPU 101 extracts parameter values corresponding to the respective parameters from the RAM parameter value list table T2, and replaces the parameters in the simulation model template with the extracted parameter values. An exemplary output m1 of a simulation model is illustrated in FIG. 21.

Next, a library generation process of step S13 will be described. As in the case of the simulation model, a library cell template in which parameters are embedded is provided.

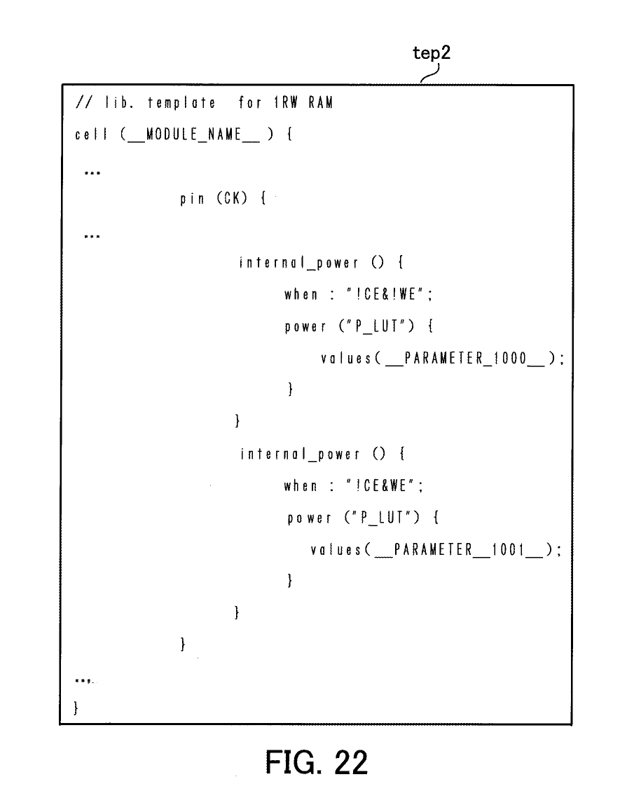

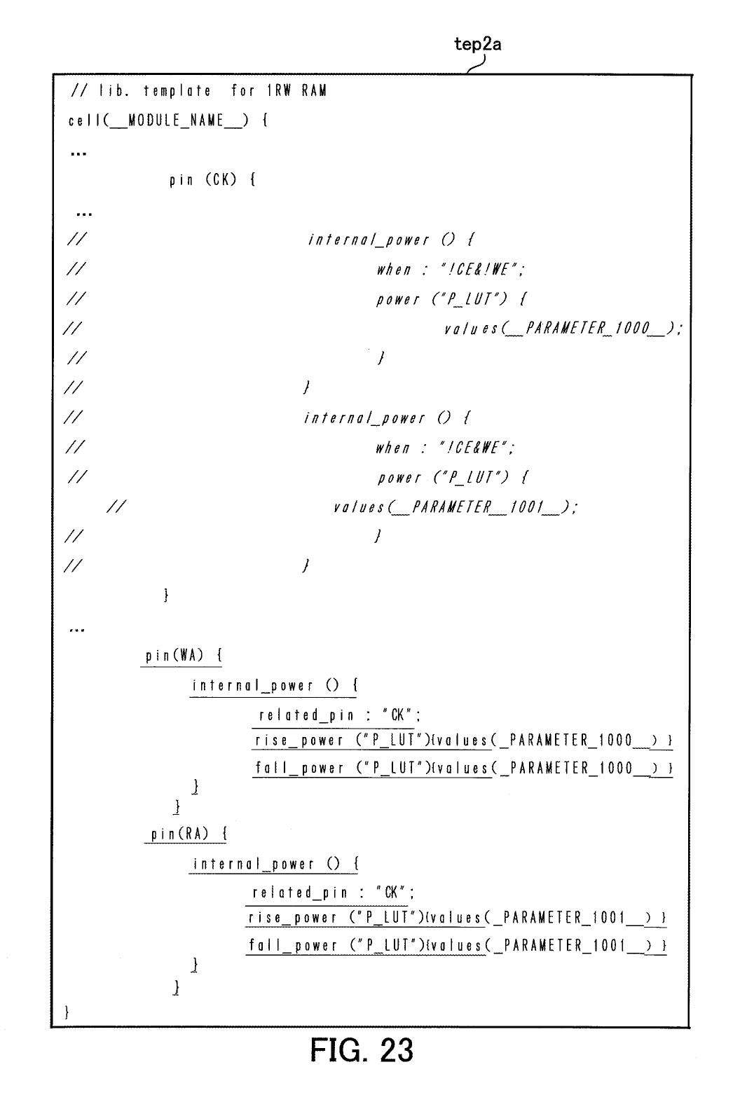

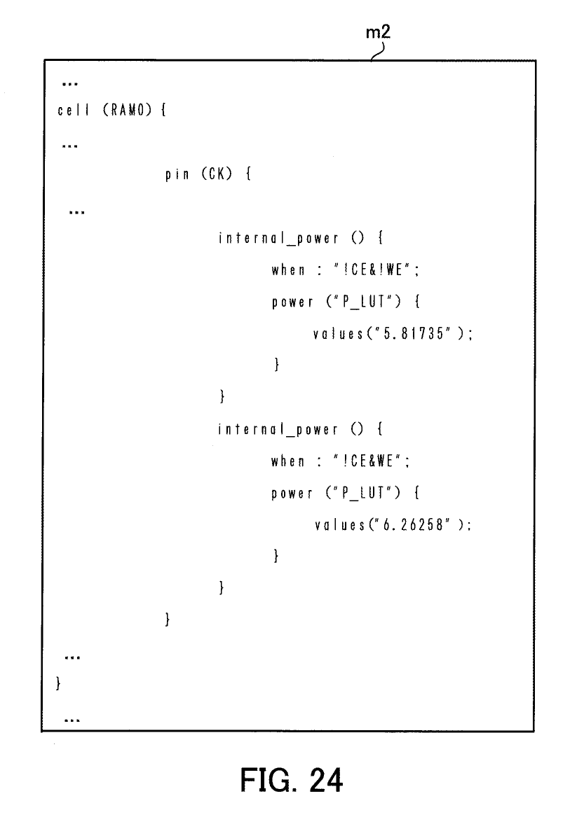

FIGS. 22 and 23 illustrate exemplary library cell templates. More specifically, FIG. 22 illustrates a related-art library cell template tep2, and FIG. 23 illustrates a library cell template tep2a according to the present technique. The CPU 101 extracts parameter values corresponding to the respective parameters from the RAM parameter value list table T2, and replaces the parameters in the library cell template with the extracted parameter values. When all the parameters are replaced, the CPU 101 outputs a library. An exemplary output m2 of a library is illustrated in FIG. 24.

In the manner described above, a simulation model and a library for a RAM are generated, and a desired data are generated. Note that the simulation model and library may be generated by generating related-art library and simulation model and then performing rewriting operations corresponding to a conversion from the one illustrated in FIG. 19 to the one illustrated in FIG. 20, and a conversion from the one illustrated in FIG. 22 to the one illustrated in FIG. 23.

As described above, according to the present embodiment, pins that allow passage of a clock during writing and reading, respectively, are added in a functional model of a memory macro, and the power consumption is calculated on the basis of the toggle rate of the clock that passes through each of the pins and the predetermined power value. Accordingly, it is possible to prevent errors in estimating the power value.

Note that, for implementing the above-described power estimation apparatus 10 as the computer 100 of FIG. 11, a program describing the functions of the power estimation apparatus 10 is provided.

The computer executes the program, so that the above-described processing functions are realized on the computer. The program may be stored in a computer-readable recording medium. Examples of computer-readable recording media include magnetic storage devices, optical discs, magneto-optical storage media, semiconductor memory devices, and the like. Examples of magnetic storage devices include hard disk drives (HDDs), flexible disks (FDs), magnetic tapes, and the like. Examples of optical discs include DVDs, DVD-RAMS, CD-ROMs, CD-RWs, and the like. Examples of magneto-optical storage media include magneto-optical disks (MOs) and the like. Note that the computer-readable recording medium storing the program does not include transitory propagating signals per se.

For distributing the program, the program may be stored and sold in the form of a portable storage medium such as DVD, CD-ROM, and the like, for example. Further, the program may be stored in a storage device of a server computer so as to be transmitted from the server computer to other computers via a network.

For executing the program, the computer stores the program recorded on the portable storage medium or the program transmitted from the server computer in its storage device. Then, the computer reads the program from its storage device, and executes processing in accordance with the program. Note that the computer may read the program directly from the portable storage medium so as to execute processing in accordance with the program. Also, the computer may sequentially receive the program from the server computer and execute processing in accordance with the received program.

The above-described processing functions may also be implemented wholly or partly by using electronic circuits such as digital signal processor (DSP), application specific integrated circuit (ASIC), programmable logic device (PLD), and the like.

According to the disclosed power estimation apparatus and power estimation method, it is possible to prevent errors in estimating the power value.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A power estimation apparatus comprising:
a memory configured to store an amount of power per clock transition in a circuit operation that consumes power; and
a processor configured to perform a procedure including:
generating a functional model in which a pin that allows passage of a clock during the circuit operation is added, and
calculating an amount of power needed during the circuit operation, by operating on a toggle rate of the clock passed through the pin and the amount of power stored in the memory.

2. The power estimation apparatus according to claim 1, wherein:
the functional model includes a functional model of a memory macro;
the circuit operation includes a write operation or a read operation of the memory macro;
the generating includes generating the pin that allows passage of the clock during the write operation or during the read operation; and
the calculating includes calculating an amount of power needed during the write operation or during the read operation, by operating on a toggle rate of the clock passed through the pin and the amount of power stored in the memory.

3. The power estimation apparatus according to claim 1, wherein:
the functional model includes a functional model of a memory macro;
the circuit operation includes a write operation and a read operation of the memory macro;
the generating includes generating a first pin that allows passage of the clock during the write operation, and generating a second pin that allows passage of the clock during the read operation; and
the calculating includes calculating an amount of power needed during the write operation, by operating on a first toggle rate of the clock passed through the first pin and a first amount of power, and calculating an amount of power needed during the read operation, by operating on a second toggle rate of the clock passed through the second pin and a second amount of power.

4. A power estimation method comprising:
generating, by a processor, a functional model in which a pin that allows passage of a clock during a circuit operation that consumes power is added; and
calculating, by the processor, an amount of power needed during the circuit operation, by operating on an amount of power per clock transition in the circuit operation and a toggle rate of the clock passed through the pin, the amount of power per clock transition in the circuit operation being stored in a memory.

5. A computer-readable storage medium storing a computer program, the computer program causing a computer to perform a procedure comprising:
generating a functional model in which a pin that allows passage of a clock during a circuit operation that consumes power is added; and
calculating an amount of power needed during the circuit operation, by operating on an amount of power per clock transition in the circuit operation and a toggle rate of the clock passed through the pin, the amount of power per clock transition in the circuit operation being stored in a memory.
